(19) United States
(12) Patent Application Publication
(10) Pub. No.: US 2025/0357036 A1
(43) Pub. Date: Nov. 20, 2025

(54) TRANSFORMER BOX PAD

(71) Applicant: Hubbell Incorporated, Shelton, CT (US)

(72) Inventors: Scott Ryan Venczel, Farragut, TN (US); Ronald Victor Melcher, Loudon, TN (US); Paul Steven Tramm, Ten Mile, TN (US); Samuel Thomas Melton, Knoxville, TN (US); John Thomas Polk, III, Townsend, TN (US)

(21) Appl. No.: 19/208,925

(22) Filed: May 15, 2025

Related U.S. Application Data
(60) Provisional application No. 63/647,842, filed on May 15, 2024.
(60) Provisional application No. 63/700,917, filed on Sep. 30, 2024.
(60) Provisional application No. 63/706,196, filed on Oct. 11, 2024.

(51) Int. Cl. H01F 27/06

(52) U.S. Cl. CPC H01F 27/06

(57) ABSTRACT

A transformer box pad that includes a base and a top. The base includes a first portion and a second portion that together at least partially define an internal volume. The top is removably coupled to the base. The top includes an upper surface and a side surface that extends from the upper surface. The upper surface can support a transformer. The side surface can cover the second portion of the base.

### CROSS-REFERENCE TO RELATED APPLICATIONS

This application claims the benefit of U.S. Provisional Application No. 63/706,196, filed Oct. 11, 2024, U.S. Provisional Application No. 63/700,917, filed Sep. 30, 2024, and U.S. Provisional Application No. 63/647,842, filed May 15, 2024, the entire contents of these are contained herein by reference in their entirety.

### FIELD

The present disclosure relates to a mounting pad. More particularly, the present disclosure relates to a modular transformer box pad.

### BACKGROUND

Transformers may be installed in residential or commercial settings to assist in power distribution in a given area. Some transformers may be installed on the ground (e.g., in a homeowner's yard) and may reduce the electrical voltage for safe use within a home or business.

A mounting pad or sleeve may be installed prior to the transformer and may be used to support the transformer. For example, the mounting pad may be at least partially buried in the ground to remain fixed. The mounting pad may include a fixed top surface that receives and supports the transformer.

Once installed, it may be difficult to service the mounting pad. In particular, the mounting pad may become damaged through a variety of scenarios. In one common example, portions of the mounting pad may crack or fracture as a result of contact with lawn equipment (e.g., a weed wacker, a lawn mower, etc.). This fracture may expose electrical components housed inside of the mounting pad, which can be dangerous to people and animals passing near the transformer.

To remedy these broken mounting pads, technicians may have to completely remove the transformer and replace the broken mounting pad by unearthing it and burying a replacement mounting pad. This is expensive, difficult, and time consuming for the technician.

### SUMMARY

Various examples of the present disclosure can overcome various of the aforementioned and other disadvantages associated with known mounting pads for transformers and offer new advantages as well.

According to one aspect of various examples of the present disclosure there is provided a modular transformer mounting pad.

According to another aspect of various examples of the present disclosure, there is provided a transformer box pad that includes a base and a cover that is removably connected to the base.

According to another aspect of various examples of the present disclosure, there is provided a transformer box pad that includes a first portion and a second portion that at least partially covers the first portion.

According to another aspect of various examples of the present disclosure, there is provided a guard that at least partially covers a surface of a transformer box pad. The guard can be removed from the transformer box pad without moving the transformer box pad.

According to another aspect of various examples of the present disclosure, there is provided a base of a transformer box pad with an outer wall, a lip spaced apart from the outer wall, and a channel disposed between the outer wall and the lip. The channel can receive soil to assist in supporting the base.

According to another aspect of various examples of the present disclosure, there is provided a transformer box pad that includes a base and a lid. The base includes an upper end with a groove. The lid includes a rib that is sized to fit within the groove to secure the lid to the base.

According to another aspect of various examples of the present disclosure, there is provided a base of a transformer box pad with an outer wall and a louver that extends from the outer wall.

According to another aspect of various examples of the present disclosure, there is provided a base of a transformer box pad with an outer wall and a louver that extends from the outer wall. The louver is inclined relative to the outer wall and is disposed radially outside of the outer wall.

According to another aspect of various examples of the present disclosure, there is provided a base of a transformer box pad that includes a louver. The louver includes a front wall and a side wall inclined relative to the front wall.

According to another aspect of various examples of the present disclosure, there is provided a transformer box pad that includes a base and a top. The base includes a first portion and a second portion that together at least partially define an internal volume. The top is removably coupled to the base. The top includes an upper surface and a side surface that extends from the upper surface. The upper surface can support a transformer. The side surface can cover the second portion of the base.

According to another aspect of various examples of the present disclosure, there is provided a transformer box pad that includes a base and a top. The base includes an outer wall that at least partially defines an internal volume and a lip spaced apart from a lower edge of the outer wall. The top is removably coupled to an upper edge of the outer wall. The top includes an upper surface and a side surface that extends from the upper surface. The upper surface can support a transformer. The side surface can cover the second portion of the base. A channel is formed between the outer wall and the lip and can assist in increasing the load strength of the outer wall.

According to another aspect of various examples of the present disclosure, there is provided a transformer box pad that includes a base, a louver, and a top. The base includes an outer wall that at least partially defines an internal volume. The louver extends from the outer wall. The louver is inclined relative to the outer wall and forms a pocket that expands the internal volume. The top is removably coupled to an upper edge of the outer wall. The top includes an upper surface and a side surface that extends from the upper surface. The upper surface can support a transformer. The side surface can cover at least a portion of the base.

According to another aspect of various examples of the present disclosure, there is provided a transformer box pad that includes a base, a recess, a louver, and a top. The base includes an outer wall that at least partially defines an internal volume. The recess is formed into the outer wall. The louver is coupled to the outer wall and formed at least partially within the recess. The louver includes a front surface that is inclined relative to the outer wall. An upper end of the front surface is disposed within the recess and a lower end of the front surface extends outside of the recess. The top is removably coupled to an upper edge of the outer wall. The top includes an upper surface and a side surface that extends from the upper surface. The upper surface can support a transformer. The side surface can cover at least a portion of the base.

According to another aspect of various examples of the present disclosure, there is provided a method of repairing a transformer box pad, the method includes removing a damaged first top from a base and connecting an undamaged second top to the base. The base remains fixed while the first top is replaced.

According to another aspect of various examples of the present disclosure, there is provided a method of using a transformer box pad, the method includes positioning a base over electrical conductors; covering a first portion of the base and leaving a second portion exposed; securing a first top to the base, wherein the top covers the second portion; and replacing the first top with a second top, wherein the first portion remains covered when the first top is removed.

According to another aspect of various examples of the present disclosure, there is provided a method of storing bases of transformer box pads. The method includes orienting a first base on a support surface. The first base includes a first louver that extends outwardly from a first outer wall. The method further includes orienting a second base proximate to the first base. The second base includes a second louver that extends outwardly from a second outer wall. The method further includes aligning the second louver with the first louver and nesting the second base with the first base.

According to another aspect of various examples of the present disclosure, there is provided a method of installing a transformer system, the method includes positioning a base in a first location, the base having a first portion and a second portion that together at least partially form an internal volume; covering the first portion; selecting a first top from a first variety and a second variety; securing the selected first top to the base, wherein side walls of the selected top cover the second portion; selecting a second top from the first variety and the second variety; and replacing the first top with the second top. The first portion remains covered when the first top is removed.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is an upper perspective view of a transformer box pad.

FIG. 2 is a lower perspective view of the transformer box pad of FIG. 1.

FIG. 3 is an exploded view of the transformer box pad of FIG. 1.

FIG. 4 is a perspective view of a base of the transformer box pad of FIG. 1.

FIG. 5 is a top view of the base of FIG. 4.

FIG. 6 is a side view of the base of FIG. 4.

FIG. 7 is an upper perspective view of a cover of the transformer box pad of FIG. 1.

FIG. 8 is a top view of the cover of FIG. 7.

FIG. 9 is a side view of the cover of FIG. 7.

FIG. 10 is a bottom view of the cover of FIG. 7.

FIG. 11 is a cross-sectional view of the transformer box pad of FIG. 1, viewed along section 11-11.

FIG. 12 is an upper perspective view of a transformer box pad with an alternate cover.

FIG. 13 is a perspective view of an alternate example of a transformer box pad.

FIG. 14 is an exploded view of the transformer box pad of FIG. 13.

FIG. 15 is a perspective view of a base of the transformer box pad of FIG. 13.

FIG. 16 is a cross-sectional view of the base of FIG. 15, viewed along section 16-16.

FIG. 17 is a perspective view of a cover of the transformer box pad of FIG. 13.

FIG. 18 is a bottom view of the cover of FIG. 17.

FIG. 19 is a cross sectional view of the cover of FIG. 17 viewed along section 19-19.

FIG. 20 is a perspective view of a further alternate example of a base of transformer box pad.

FIG. 21 is a side view of the base of FIG. 20.

FIG. 22 is a top view of the base of FIG. 20.

FIG. 23 is a cross-sectional view of the base of FIG. 20, viewed along section 23-23.

FIG. 24 is a perspective view of the base of FIG. 20 stacked with a second base.

### DETAILED DESCRIPTION

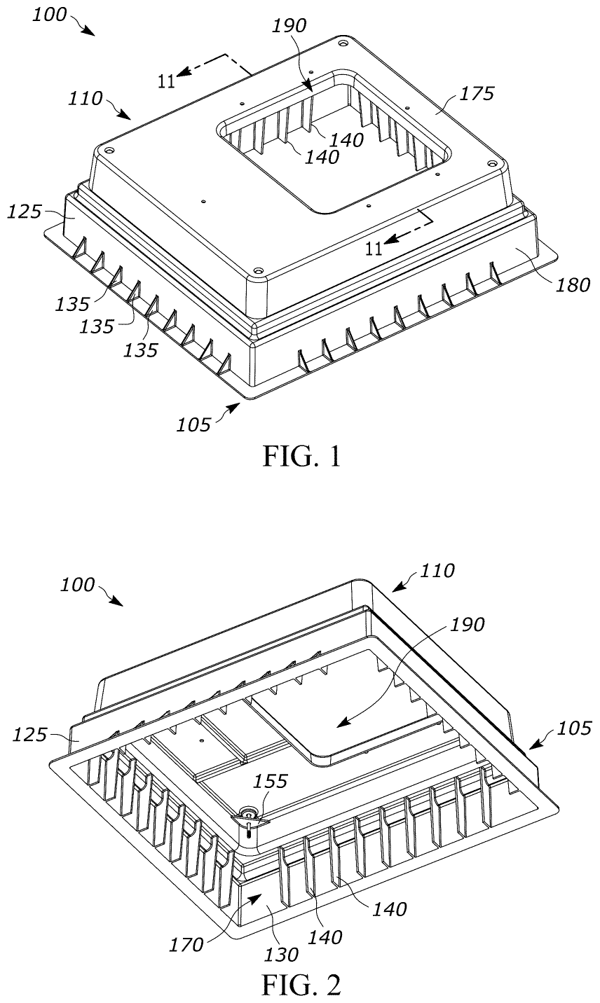

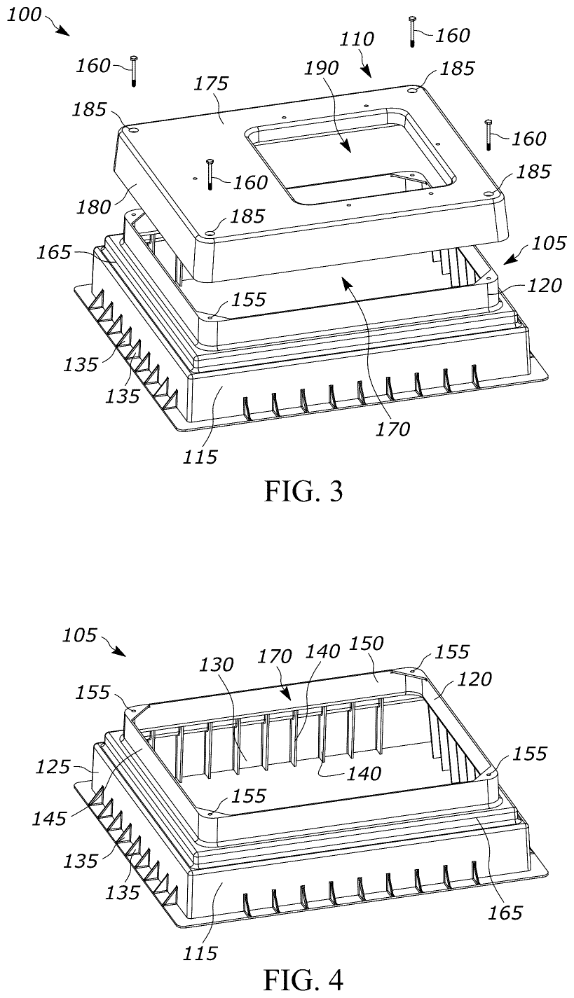

FIGS. 1 to 3 illustrate a transformer box pad 100 that can be used to support a transformer (not shown). The transformer box pad 100 includes a base 105 and a cover 110 that are coupled together.

FIGS. 4 to 6 illustrate the base 105 with a lower portion 115 and an upper portion 120. The base 105 may be at least partially constructed from a rigid material (e.g., fiberglass, plastic, polymer concrete, concrete, etc.).

The lower portion 115 may include an outer surface 125 and an inner surface 130 that is opposite to the outer surface 125. The lower portion 115 may form a substantially rectangular perimeter, although other examples may include a different shape.

In some forms, the outer surface 125 may include at least one outer rib 135. For example, the illustrated base 105 includes a plurality of ribs 135 extending along each face of the outer surface 125. The ribs 135 may be substantially triangular in shape, although any other shape may be used.

In certain forms, each outer rib 135 is between about 0.1 inches and about 10 inches in length. In certain forms, each outer rib 135 is between about 0.5 inches and about 7.5 inches in length. In certain forms, each outer rib 135 is between about 1 inch and about 5 inches in length. In certain forms, each outer rib 135 is between about 2.5 inches and about 3 inches in length.

In certain forms, one or more of the outer ribs 135 may extend to a midpoint on the outer surface 125 of the lower portion 115. In other examples, one or more of the outer ribs 135 may extend to a maximum length that is below the midpoint of the outer surface 125 of the lower portion 115. In still other examples, one or more of the outer ribs 135 may extend to a length that is above the midpoint of the outer surface 125 of the lower portion 115. The illustrated example (see e.g., FIG. 6) shows all of the outer ribs 135 extending to the same location, however as described above, one or more outer ribs 135 may have a different length than the surrounding outer ribs 135. Additionally, other examples may include outer ribs 135 of different lengths on different sides of the lower portion 115. For example, all of the outer ribs 135 on one side may be the same length, which may be different than the length of one or more of the outer ribs 135 on another side.

In some forms, the inner surface 130 may include at least one inner rib 140. For example, the illustrated base 105 includes a plurality of ribs 140 extending along each face of the inner surface 130. The ribs 140 may have a substantially elongated shape, although any other shape may be used. The illustrated inner ribs 140 may extend the entire length of the inner surface 130 and may be longer than the outer ribs 135 (although other sizes may be used).

In certain forms, all of the inner ribs 140 may extend to the same location. However as described above, one or more inner ribs 140 may have a different length than the surrounding inner ribs 140. Additionally, other examples may include inner ribs 140 of different lengths on different sides of the lower portion 115. For example, all of the inner ribs 140 on one side may be the same length, which may be different than the length of one or more of the inner ribs 140 on another side.

The upper portion 120 may be formed above the lower portion 115 (e.g., as oriented in FIG. 4). The lower and upper portions 115, 120 may be aligned with one another so that they are oriented in a concentric configuration. However, other examples, may include the center of the upper portion 120 in a different location than the center of the lower portion 115.

The upper portion 120 may include an outer surface 145 and an inner surface 150 that is opposite to the outer surface 145. The upper portion 120 may form a substantially rectangular perimeter, although other examples may include a different shape.

In certain forms, an outermost width of the outer surface 145 of the upper portion 120 may be less than the width of the inner surface 130 of the lower portion 115. In other words, the outer surface 145 of the upper portion 120 is disposed radially within the inner surface 130 of the lower portion 115 (see e.g., FIG. 11). The base 105 may include a stepped orientation between the lower portion 115 and the upper portion 120.

In some forms, an upper end of the upper portion 120 (e.g., the end opposite to the lower portion 115) may include at least one mounting feature 155 (e.g., four shown). The illustrate mounting features 155 are apertures disposed proximate to the corners of the sides of the upper portion 120. As described in more detail below, the mounting features 155 may receive fasteners 160. In alternate examples, one or more of the mounting features 155 may be formed as a projection instead of an aperture and may be inserted through an aperture on another body.

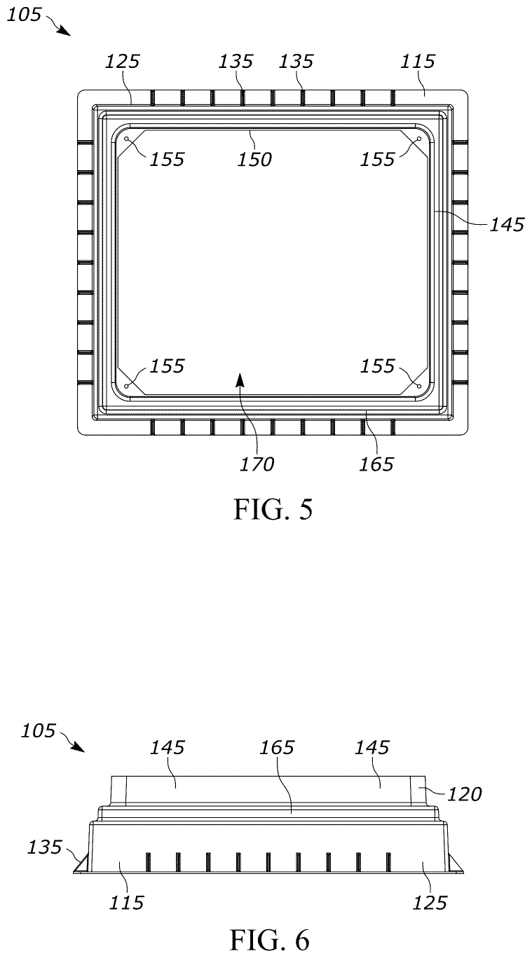

In certain forms, each mounting feature 155 may be disposed in a corner of the upper portion 120 and extend between two adjacent sides of the upper portion 120. Each illustrated mounting feature 155 in FIG. 5 may be fully received within the respective corner and may have a substantially triangular shape. Other examples may include alternate shapes and/or alternate positions. For example, one or more mounting features 155 may only extend from one side (e.g., in a cantilever manner).

In some forms, a middle portion 165 may be disposed between the lower and upper portions 115, 120. The middle portion 165 may be substantially rectangular in shape, similar to the lower and upper portions 115, 120.

As shown in FIG. 6, certain forms of the middle portion 165 may be a stepped portion between the lower and upper portions 115, 120. For example, the base 105 may include two steps: one between the lower portion 115 and the middle portion 165, and one between the middle portion 165 and the upper portion 120.

In certain forms, one or more of the inner ribs 140 may extend along the entire length of the inner surface of the middle portion 165. In other examples, one or more of the inner ribs 140 may extend to a maximum length that is at the midpoint of the inner surface of the middle portion 165. In still other examples, one or more of the inner ribs 140 may extend to a length that is below the midpoint of the inner surface of the middle portion 165.

Returning to FIG. 4, the base 105 may include an internal volume 170 that is at least partially formed be the inner surfaces 130, 150. The illustrated base 105 may be open on the upper and lower ends. As described in more detail below, this may permit electrical elements (e.g., conductors) to ingress and egress the base 105.

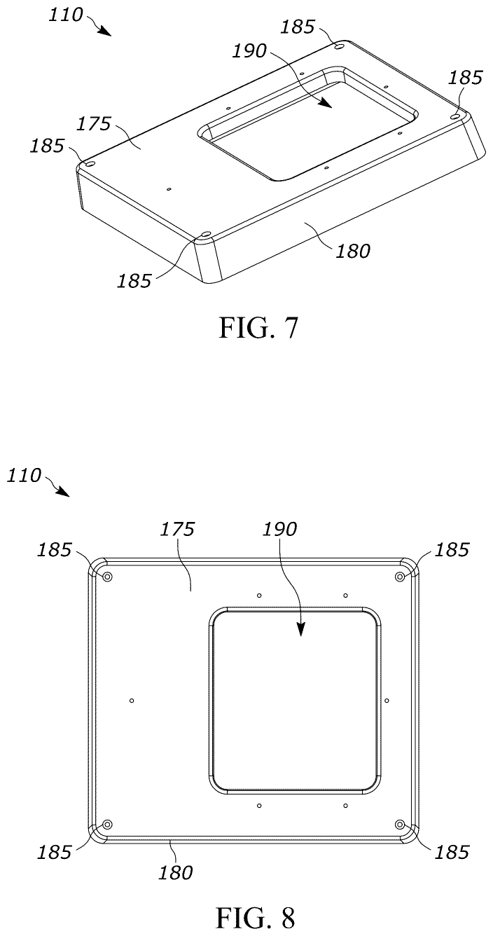

FIGS. 7 to 10 illustrate one example of the cover 110. The cover 110 may include an upper surface 175 and at least one side surface 180. The illustrated cover 110 includes four side surfaces 180 that form a complete perimeter around the upper surface 175.

As shown in FIGS. 7 and 8, the upper surface 175 may include at least one mounting feature 185. For example, the upper surface 175 includes a plurality of holes (e.g., four shown). As described in more detail below, the holes 185 may receive fasteners 160.

In some forms, the cover 110 may include an opening 190 extending through the upper surface 175. The illustrated opening 190 is substantially rectangular in shape, although other examples of the opening 190 may include a different shape (e.g., circular, elliptical, triangular, etc.). A center of the illustrated opening 190 is spaced apart from a center of the cover 110. However, other examples may include an opening 190 that is centered on the upper surface 175.

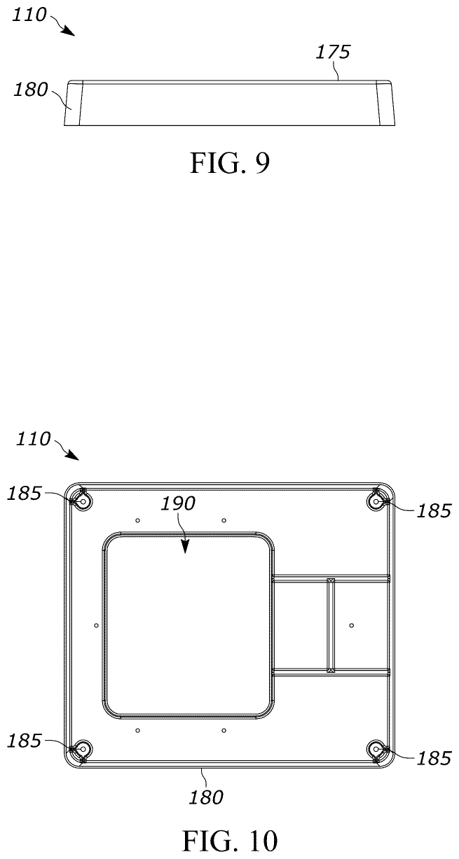

As shown in FIG. 9, the side surfaces 180 may be at least partially inclined relative to the upper surface 175. For example, a free end of the side surfaces 180 (e.g., end distal to the upper surface 175) may be wider than the width of the upper surface 175. In other examples, the side surfaces 180 may be perpendicular to the upper surface 175, or the free end of the side surfaces 180 may be radially inside of the upper surface 175.

In use, the base 105 may positioned on the ground to at least partially cover one or more electrical components (not shown). More particularly, the base 105 may be at least partially buried in the earth. For example, the lower portion 115 may buried under ground. The middle portion 165 may also be at least partially buried in some examples.

The base 105 may be positioned so that electrical components that are also underground can enter the internal volume 170 of the base 105. These electrical components may be electrical conductors that transport high voltage electrical energy.

Once the base 105 is positioned at least partially underground, the cover 110 may be coupled to the base. As shown in FIG. 11, the side surfaces 180 of the cover 110 may be wider than the upper portion 120 of the base 105. The cover 110 may fit around the upper portion 120 so that the side surfaces 180 are radially outside of the outer surface 145 of the upper portion 120. The cover 110 may rest of the stepped surface between the middle portion 165 and the upper portion 120.

In this example, both the lower portion 115 and the middle portion 165 are buried underground. When the cover 110 is positioned over the upper portion 120, substantially none of the base 105 is exposed.

In other examples, only the lower portion 115 may be buried underground. The side surfaces 180 of the cover 110 may be longer and wider and may extend down over the middle portion 165 when coupled to the base 105. In this example, the cover 110 may rest on the stepped surface between the lower portion 115 and the middle portion 165. Like with the example illustrated in FIG. 11, substantially no portion of the base 105 may be exposed when the cover 110 is connected to the base 105.

Once the cover 110 is positioned over the base 105, fasteners 160 may be inserted through the aligned mounting features 155 and holes 185. The fasteners 160 may secure the cover 110 to the base 105 to limit or prevent unintended or unauthorized removal of the cover 110. For example, the fasteners 160 may be tamper-proof fasteners that limit unauthorized people from removing the fasteners 160.

In either configuration, the cover 110 may assist in protecting the base 105 from damage. For example, because the base 105 is not exposed (e.g., because it is underground and/or encased by the cover 110), it is less susceptible to damage (e.g., from lawn care equipment). In some forms, the cover 110 may be constructed from a material designed to withstand damage (e.g., fiberglass, plastic, polymer concrete, concrete, etc.).

However, if the cover 110 is damaged (e.g., fractures and exposes the base 105), the modular configuration of the transformer box pad 100 allows the cover 110 to be replaced without having to replace the base 105. This helps to simplify the repair and replacement of a damaged transformer box pad 100 because the base 105 does not need to be dug up and a new base 105 buried.

In certain forms (not shown), one or more guards may be used to provide protection to the cover 110. For example, a guard may be positioned proximate to a corner of the cover 110. The guard may be formed form a similar material as the cover 110.

In one form, the guard may include a curved shape with a first end and a second end. The first end may be angled relative to the second end and may include an aperture. When assembling the transformer box pad 100, the aperture of the guard may be aligned with one of the mounting features 155 and one of the holes 185. The fastener 160 can be inserted through all three of the guard aperture, the mounting feature 155, and the hole 185 to secure the three elements together. A guard may be positioned at each of the corners of the cover 110.

In one form, the guard may be approximately the same length of the cover 110. For example, each guard may have substantially the same length as the cover 110 to that the cover 110 is not exposed.

Like the cover 110 protecting the base 105, the guard may protect a portion of the cover 110. For example, the guard may protect one or more corners of the cover 110. If the guard is damaged, a technician may replace the guard without replacing either the cover 110 or the base 105. The modular assembly of the guards may also assist in simplifying the repair and replacement of the transformer box pad 100.

Once assembled (see e.g., FIG. 1) and installed in the ground, a transformer (not shown) may be positioned on the upper surface 175 of the cover 110. Specifically, the transformer may be positioned to cover the opening 190. The electrical components housed within the volume 170 may extend through the opening and connect to the transformer.

When a cover 110 or guard becomes damaged as described above, the transformer may be removed from the cover 110 so that the damaged cover 110 can be removed and replaced with a new cover 110. In some examples, the transformer may not cover the guard and a damaged guard may be removed and replaced without removing the transformer from the upper surface 175.

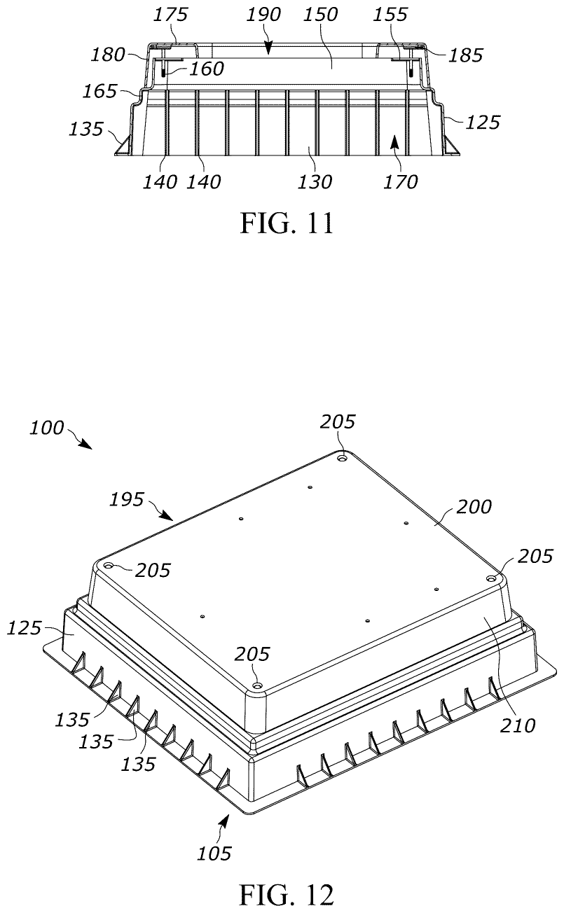

In other examples, builders of new developments may install the transformer box pad 100 prior to receiving the transformer that will eventually be supported by the particular transformer box pad 100. Because there may be an extended timeframe for receiving the transformer, an alternate cover 195 (see e.g., FIG. 12) may be used. The cover 195 may be similar to the cover 110 and includes an upper surface 200 with holes 205 and one or more side surfaces 210. Unlike the cover 110, the cover 195 may not include the opening 190, which limits access into the volume 170 of the base.

The cover 195 can enclose and protect electrical components housed in the volume 170 of the base 105 until the transformer is ready to be installed. At that point, the cover 195 can be removed and replaced with the cover 110. When replacing the cover 195, the base 105 may remain in the ground and is not required to be changed.

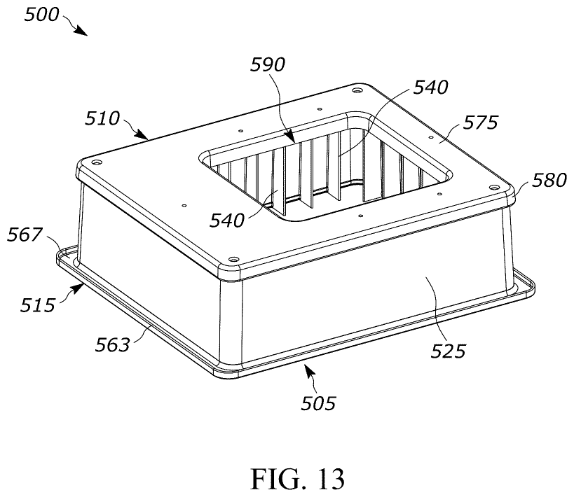

FIGS. 13 to 19 illustrate a transformer box pad 500, which may be an alternate example to the transformer box pad 100. Only some similarities and differences between the transformer box pad 100 and the transformer box pad 500 may be described below. Similar elements in the transformer box pad 500 may include the same reference number plus “400”.

Similar to the transformer box pad 100, the transformer box pad 500 can be used to support a transformer (not shown). The transformer box pad 500 includes a base 505 and a cover 510 that are coupled together. The base 505 and/or the cover 510 may be constructed from a rigid material (e.g., fiberglass, plastic, polymer concrete, concrete, etc.).

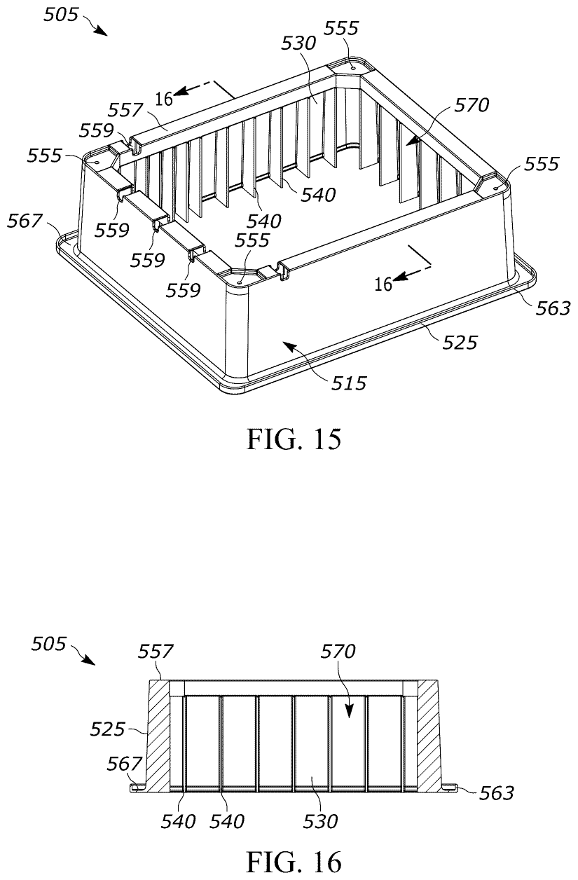

As shown in FIGS. 15 and 16, the base 505 may include an outer surface 525 and an inner surface 530 that is opposite to the outer surface 525. The lower portion 515 may form a substantially rectangular perimeter, although other examples may include a different shape.

In some forms, the inner surface 530 may include at least one inner rib 540. For example, the illustrated base 505 includes a plurality of ribs 540 extending along each face of the inner surface 530. The ribs 540 may have a substantially elongated shape, although any other shape may be used. The illustrated inner ribs 540 may extend the entire length of the inner surface 530. Additionally, the illustrated inner ribs 540 may all be similarly shaped, although other examples may include one or more inner ribs 540 with different shapes.

In some forms, an upper end (e.g., as viewed in FIG. 15) may include at least one mounting feature 555 (e.g., four shown). The illustrate mounting features 555 are apertures disposed proximate to the corners of the base 505. As described in more detail below, the mounting features 555 may receive fasteners 560. In alternate examples, one or more of the mounting features 555 may be formed as a projection instead of an aperture and may be inserted through an aperture on another body.

In certain forms, the upper end of the base 505 may include a ledge 557, which may have a thickness that extends from the outermost surface if the base 505 toward a center of the base 505. Each mounting feature 555 may be disposed in a corner between two adjacent sides of the base 505. Each illustrated mounting feature 555 may be fully received within the respective corner and may have a substantially triangular shape. Other examples may include alternate shapes and/or alternate positions. For example, one or more mounting features 555 may only extend from one side (e.g., in a cantilever manner).

In certain forms, the ledge 557 may extend around substantially the entire perimeter of the upper end of the base 505. The ledge 557 may include substantially planar surfaces. In the illustrated example, each of the mounting features 555 may be formed as depressions between adjacent planar portions. However, one or more mounting features 555 in other examples may be coplanar with or raised with respect to the surrounding planar portions.

In one form, grooves 559 may be formed within the planar portion of the ledge 557. In the illustrated example, each groove 559 may have a substantially semi-cylindrical shape, although one or more grooves 559 may have a different shape (e.g., semi-circular, semi-elliptical, rectangular, etc.). The grooves 559 may extend entirely through the width of the ledge 557.

With continued reference to FIG. 15, the base 505 may include an internal volume 570 that is at least partially formed be the inner surface 530. The illustrated base 505 may be open on the upper and lower ends. As described in more detail below, this may permit electrical elements (e.g., conductors) to ingress and egress the base 505.

As shown in FIG. 16, the lower portion 515 may extend outwardly from the outer surface 525. In the illustrated example, a flange or lip 563 may extend upwardly from the lower portion 515 (e.g., toward the ledge 557). The lip 563 may extend as a cantilever portion and a channel 567 may be formed between the lip and the outer surface 525. As described in more detail below, the lip 563 and the channel 567 may assist in securing the transformer box pad 100 in an upright position.

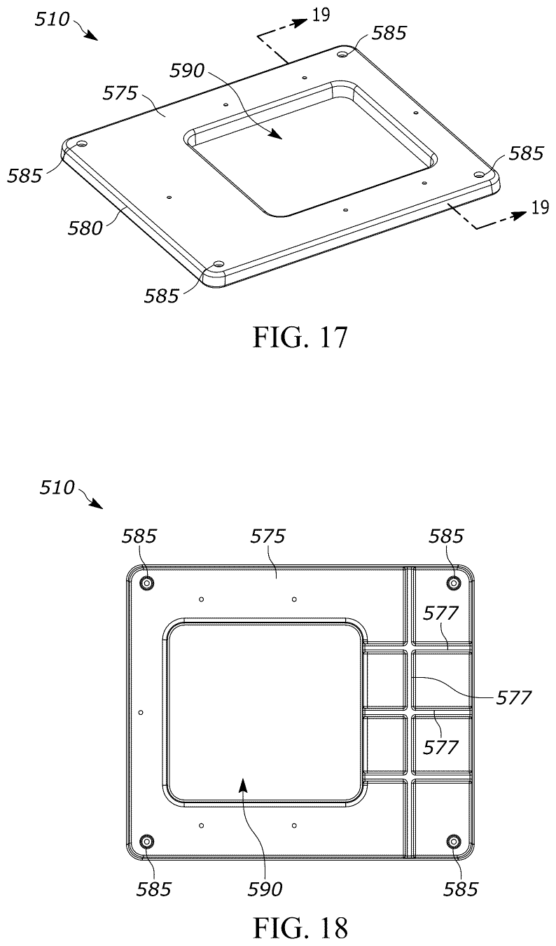

FIGS. 17 to 19 illustrate one example of the cover 510. The cover 510 may include an upper surface 575 and at least one side surface 580. The illustrated cover 510 includes four side surfaces 580 that form a complete perimeter around the upper surface 575.

In some forms, the upper surface 575 may include at least one mounting feature 585. For example, the upper surface 575 includes a plurality of holes (e.g., four shown). As described in more detail below, the holes 585 may receive fasteners 560.

In some forms, the cover 510 may include an opening 590 extending through the upper surface 575. The illustrated opening 590 is substantially rectangular in shape, although other examples of the opening 590 may include a different shape (e.g., circular, elliptical, triangular, etc.). A center of the illustrated opening 590 is spaced apart from a center of the cover 510. However, other examples may include an opening 590 that is centered on the upper surface 575.

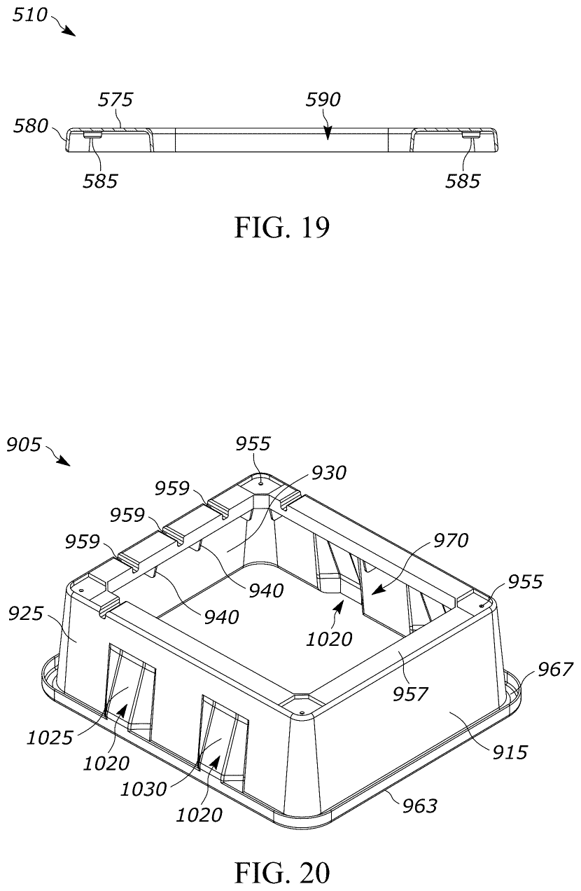

As shown in FIG. 19, the side surfaces 580 may be at least partially inclined relative to the upper surface 575. For example, a free end of the side surfaces 580 (e.g., end distal to the upper surface 575) may be wider than the width of the upper surface 575. In other examples, the side surfaces 580 may be perpendicular to the upper surface 575, or the free end of the side surfaces 580 may be radially inside of the upper surface 575.

In use, the base 505 may positioned on the ground to at least partially cover one or more electrical components (not shown). More particularly, the base 505 may be at least partially buried in the earth. For example, the lower portion 515 may buried under ground. When the base 505 is at least partially buried, soil may fill the channel 567. The lip 563 may assist in increasing the load strength of the lower portion 515 to limit unintended or unauthorized removal of the base 505 from the ground. In other words, the lip 563 may assist in maintaining soil within the channel 567, thereby assisting to hold the base 505 down when surrounding soil shifts.

The base 505 may be positioned so that electrical components that are also underground can enter the internal volume 570 of the base 505. These electrical components may be electrical conductors that transport high voltage electrical energy.

Once the base 505 is positioned at least partially underground, the cover 510 may be coupled to the base. Returning to FIG. 13, the side surfaces 580 of the cover 510 may be wider than the upper portion of the base 505. The cover 510 may fit around the upper portion so that the side surfaces 580 are radially outside of the outer surface 525.

As shown in FIG. 18, some forms of the cover 510 may include ribs 577 on an inner face of the upper surface 575. The illustrated ribs 577 may have a substantially semi-circular shape, although other examples of a rib 577 may have a different shape. The illustrated ribs 577 may also be arranged with three parallel ribs 577 and a perpendicular rib 577, although any other number or orientation of ribs 577 may be used.

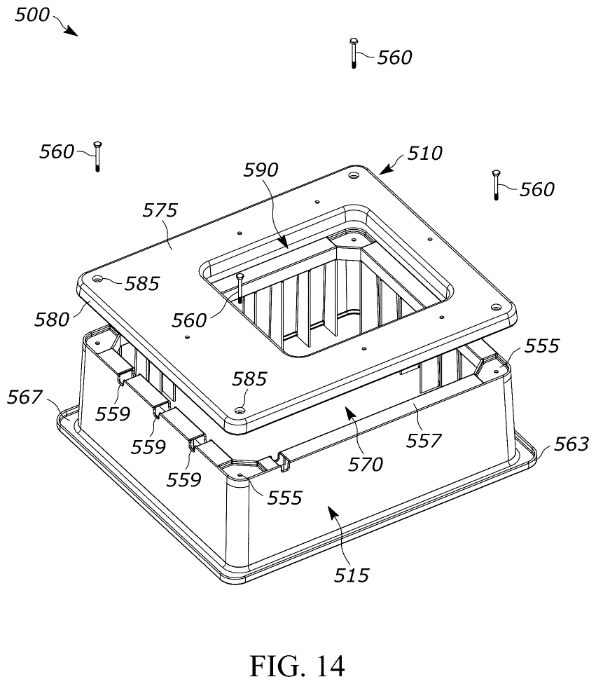

When positioning the cover 510 over the base 505 (see e.g., FIG. 14), the cover 510 may be oriented so that the ribs 577 are aligned with the grooves 559. As the cover 510 is coupled to the base 505, the ribs 577 may be inserted into the grooves 559. The shape of the grooves 559 may be substantially complementary to the shape of the ribs 577 to permit the ribs 577 to fit snuggly within the grooves 559. In certain forms, the ribs 577 may be press fit, snap fit, and/or friction fit into the grooves 559. In other forms, the ribs 577 may rest in the grooves 559.

In some examples, at least part the lower portion 515 may be buried underground. The side surfaces 580 of the cover 510 extend down over at least a portion of the outer surface 525 when coupled to the base 505.

Once the cover 510 is positioned over the base 505, fasteners 560 may be inserted through the aligned mounting features 555 and holes 585. The fasteners 560 may secure the cover 510 to the base 505 to limit or prevent unintended or unauthorized removal of the cover 510. For example, the fasteners 560 may be tamper-proof fasteners that limit unauthorized people from removing the fasteners 560.

Like the cover 110, the cover 510 may assist in protecting the base 505 from damage. For example, because the base 505 is not exposed (e.g., because it is underground and/or encased by the cover 510), it is less susceptible to damage (e.g., from lawn care equipment). In some forms, the cover 510 may be constructed from a material designed to withstand damage (e.g., fiberglass, plastic, polymer concrete, concrete, etc.).

However, if the cover 510 is damaged (e.g., fractures and exposes the base 505), the modular configuration of the transformer box pad 500 allows the cover 510 to be replaced without having to replace the base 505. This helps to simplify the repair and replacement of a damaged transformer box pad 100 because the base 505 does not need to be dug up and a new base 505 buried.

In some forms, one or more guards may be used to provide protection to the cover 510. For example, a guard may be positioned proximate to a corner of the cover 510. The guard may be formed form a similar material as the cover 510. The guard used with the cover 510 may be similar to the guard used with the cover 110.

FIGS. 20 to 24 illustrate a base 905 for use with a transformer box pad, which may be a further alternate example to the base 105 and/or base 505. Only some similarities and differences between the prior bases 105, 505 and the base 905 may be described below. Similar elements in the base 905 may include the same reference number plus “800”.

The base 905 may be coupled together with a cover (e.g., cover 510) to form a transformer box pad, which together may form a transformer box pad for supporting a transformer (not shown). The base 905 may be constructed from a rigid material (e.g., fiberglass, plastic, polymer concrete, concrete, etc.).

As shown in FIG. 20, the base 905 may include an outer surface 925 and an inner surface 930 that is opposite to the outer surface 925. The lower portion 915 may form a substantially rectangular perimeter, although other examples may include a different shape.

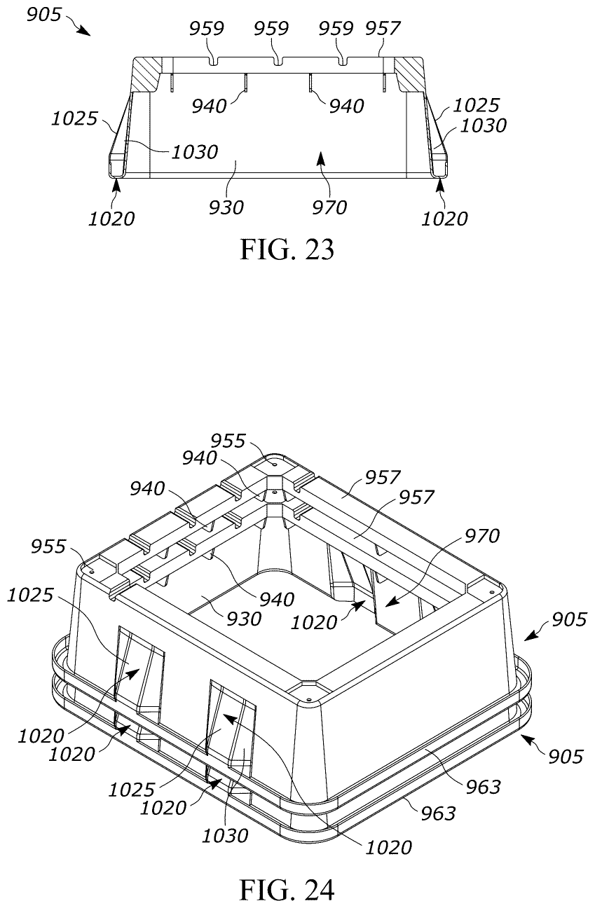

In some forms, the inner surface 930 may include at least one inner rib 940. For example, the illustrated base 905 includes a plurality of ribs 940 extending at least partially along each face of the inner surface 930. As illustrated in FIG. 23, the inner ribs 940 may extend along a portion (e.g., less than half) of the length of the inner surface 930. For example, the ribs 940 may be shorter than the ribs 540 (e.g., as illustrated in FIG. 16). Additionally, the illustrated inner ribs 940 may all be similarly shaped, although other examples may include one or more inner ribs 940 with different shapes.

In some forms, an upper end (e.g., as viewed in FIGS. 20 and 22) may include at least one mounting feature 955 (e.g., four shown). The illustrate mounting features 955 are apertures disposed proximate to the corners of the base 905. As described in more detail below, the mounting features 955 may receive fasteners. In alternate examples, one or more of the mounting features 955 may be formed as a projection instead of an aperture and may be inserted through an aperture on another body.

In certain forms, the upper end of the base 905 may include a ledge 957, which may have a thickness that extends from the outermost surface if the base 905 toward a center of the base 905. Each mounting feature 955 may be disposed in a corner between two adjacent sides of the base 905. Each illustrated mounting feature 955 may be fully received within the respective corner and may have a substantially triangular shape. Other examples may include alternate shapes and/or alternate positions. For example, one or more mounting features 955 may only extend from one side (e.g., in a cantilever manner).

In certain forms, the ledge 957 may extend around substantially the entire perimeter of the upper end of the base 905. The ledge 957 may include substantially planar surfaces. In the illustrated example, each of the mounting features 955 may be formed as depressions between adjacent planar portions. However, one or more mounting features 955 in other examples may be coplanar with or raised with respect to the surrounding planar portions.

In one form, grooves 959 may be formed within the planar portion of the ledge 957. In the illustrated example, each groove 959 may have a substantially semi-cylindrical shape, although one or more grooves 959 may have a different shape (e.g., semi-circular, semi-elliptical, rectangular, etc.). The grooves 959 may extend entirely through the width of the ledge 957.

With continued reference to FIG. 20, the base 905 may include an internal volume 970 that is at least partially formed be the inner surface 930. The illustrated base 905 may be open on the upper and lower ends. As described in more detail below, this may permit electrical elements (e.g., conductors) to ingress and egress the base 905.

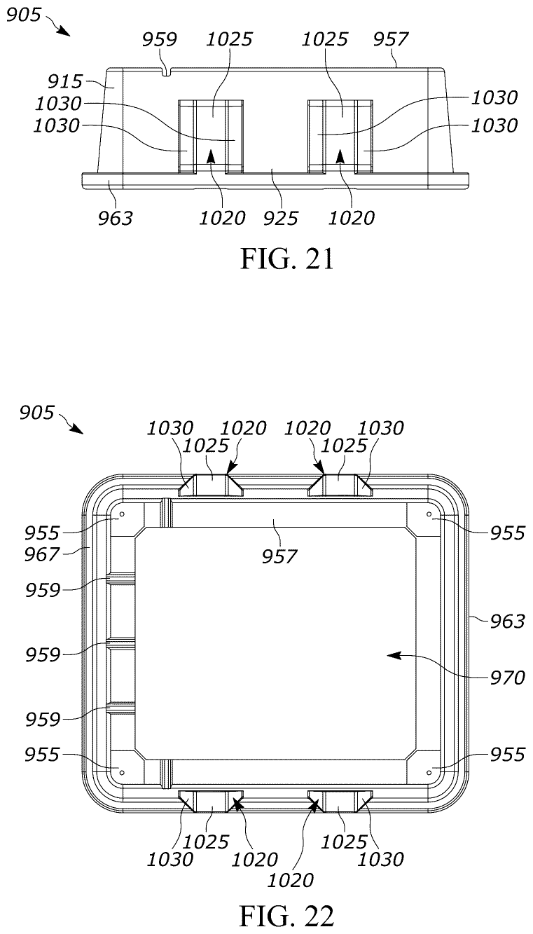

As shown in FIGS. 20 and 21, the lower portion 915 may extend outwardly from the outer surface 925. In the illustrated example, a flange or lip 963 may extend upwardly from the lower portion 915 (e.g., toward the ledge 957). The lip 963 may extend as a cantilever portion and a channel 967 may be formed between the lip 963 and the outer surface 925. The lip 963 and the channel 967 may be similar to the lip 563 and the channel 567 and may assist in securing the base 905 in an upright position.

Returning to FIGS. 20 and 21, the outer surface 925 of the base 905 may include one or more louvers 1020. For example, the illustrated example may a pair of louvers 1020 on two opposing walls (e.g., four total louvers 1020), although an alternate example of the base 905 may include any number and/or positioning of the louvers 1020.

In the illustrated example, each louver 1020 may include a front wall 1025 and a pair of side walls 1030 formed on either side of the front wall 1025. The front wall 1025 and the side walls 1030 may connect to the surrounding wall of the outer surface 925 so that there is no gap between the louvers 1020 and the remainder of the outer surface 925.

In some forms, the front wall 1025 may be inclined relative to the remaining outer surface 925. For example, the front wall 1025 may extend across the channel 967 and to the lip 963. At least a portion of the front wall 1025 therefore may be radially outside of the surrounding outer surface 925.

In some forms, the side walls 1030 may be inclined relative to the front wall 1025. For example, each side wall 1030 may extend from an edge of the front wall 1025 toward the surrounding outer surface 925. At least a portion of each side wall 1030 therefore may be radially outside of the surrounding outer surface 925.

As shown in FIG. 22, the louvers 1020 oriented symmetrically about two perpendicular axes. For example, the pair of louvers 1020 on one side of the base 905 may be spaced apart the same distance as the pair of louvers 1020 on the other side of the base 905. Additionally, the angle and length of each of the walls (e.g., the front walls 1025 and the side walls 1030) may be substantially the same on each of the louvers 1020.

As shown in FIG. 23, each louver 1020 may project outwardly from a center of the base 905. The inner surface 930 may substantially follow the outer surface 925, so that the internal volume 970 may be larger as compared to other examples (e.g., the internal volume 570).

With continued reference to FIG. 23, the ribs 940 may extend from an upper end of the base 905 (e.g., proximate to the ledge 957) toward the lower end (e.g., toward the lip 963). As described above, the ribs 940 may not extend the entire length between the ledge 957 and the lip 963. For example, each rib 940 may be disposed substantially above an upper end of the louver 1020. As shown in the illustrated example, the ribs 940 may not substantially overlap with the walls 1025, 1030 of a louver 1020 (e.g., along a horizontal axis as viewed in FIG. 23).

As shown in FIG. 24, multiple bases 905 may be stacked together. This may assist in the transport and/or storage of multiple bases 905 by permitting more bases 905 to occupy a given volume of space (e.g., a shipping container, a warehouse, etc.).

For example, the bases 905 may be oriented so that the orientation of the louvers 1020 on both bases 905 are aligned. The additional spaced of the internal volume 970 formed by the projection of the louvers 1020 may provide space for the outer surface of the lower louvers 1020 to be received. In other words, the bases 905 may be stacked so that front and side walls 1025, 1030 of a lower base 905 is received within the internal volume 970 of the upper base 905.

When stacking multiple bases 905, the internal ribs 940 may be positioned to limit interference with the stacking. For example, because the ribs 940 to not extend substantially below the upper end of the louvers 1020, the ribs 940 may not block an outer surface of a louver 1020 on the lower base 905 from being received proximate to the inner surface of a louver 1020 on the upper base 905.

In some forms, the ribs 940 of one base 905 may contact the ledge 957 of another base 905 when the bases 905 are stacked together. The ribs 940 of the upper base 905 may limit the total distance that the upper base 905 can be inserted onto lower base 905. This may limit bases 905 from becoming stuck together and permit easier decoupling of nested bases 905.

In use, the base 905 may be used like either the base 105 or the base 505. For example, the base 905 may be at least partially buried and positioned around an electrical device. A cover (e.g., cover 510) may be coupled to the base 105 to at least partially enclose the volume 970. The cover 510 may similarly assist in protecting the base 905 from damage.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A transformer box pad comprising:
a base including a first portion and a second portion that together at least partially define an internal volume; and
a top removably coupled to the base, the top including an upper surface and a side surface that extends from the upper surface,
wherein the upper surface is configured to support a transformer, and
wherein the side surface is configured to cover the second portion of the base.

2. The transformer box pad of claim 1, wherein the top includes an opening that is configured to allow communication between the internal volume and the transformer.

3. The transformer box pad of claim 1, wherein the top includes a solid surface that is configured to enclose the internal volume.

4. The transformer box pad of claim 1,
wherein the top includes a first aperture and the base includes a second aperture, and
wherein a fastener is inserted through the first aperture and the second aperture to couple the top to the base.

5. The transformer box pad of claim 4, wherein the fastener is an anti-tamper screw.

6. The transformer box pad of claim 1, further comprising a guard removably coupled to the top and covering at least a portion of the side surface.

7. The transformer box pad of claim 6, wherein the top includes a first aperture, the base includes a second aperture, and the guard includes a third aperture, and a fastener is inserted through the first aperture, the second aperture, and the third aperture to couple the top, base, and guard together.

8.-20. (canceled)

21. A transformer box pad comprising:
a base including an outer wall that at least partially defines an internal volume and a lip spaced apart from a lower edge of the outer wall; and
a top removably coupled to an upper edge of the outer wall, the top including an upper surface and a side surface that extends from the upper surface,
wherein the upper surface is configured to support a transformer;
wherein the side surface is configured to cover the second portion of the base; and
wherein a channel is formed between the outer wall and the lip and is configured to assist in increasing the load strength of the outer wall.

22. The transformer box pad of claim 21, wherein the top includes an opening that is configured to allow communication between the internal volume and the transformer.

23. The transformer box pad of claim 21, wherein the upper edge includes a groove that extends through the outer wall, and wherein the top includes a rib configured to be received within the groove.

24. The transformer box pad of claim 23, wherein the rib and groove are connectable with a snap fit.

25. The transformer box pad of claim 21, wherein the top includes a first aperture and the base includes a second aperture, and wherein a fastener is inserted through the first aperture and the second aperture to couple the top to the base.

26. The transformer box pad of claim 21, further comprising a guard removably coupled to the top and covering at least a portion of the side surface.

27. The transformer box pad of claim 26, wherein the top includes a first aperture, the base includes a second aperture, and the guard includes a third aperture, and a fastener is inserted through the first aperture, the second aperture, and the third aperture to couple the top, base, and guard together.

28. A transformer box pad comprising:
a base including an outer wall that at least partially defines an internal volume;
a louver that extends from the outer wall, wherein the louver is inclined relative to the outer wall and forms a pocket that expands the internal volume; and
a top removably coupled to an upper edge of the outer wall, the top including an upper surface and a side surface that extends from the upper surface,
wherein the upper surface is configured to support a transformer; and
wherein the side surface is configured to cover at least a portion of the base.

29. The transformer box pad of claim 28, further comprising a lip spaced apart from a lower edge of the outer wall, wherein a channel is formed between the outer wall and the lip and is configured to assist in increasing the load strength of the outer wall.

30. The transformer box pad of claim 29, wherein the louver extends across the channel to an outer edge of the lip.

31. The transformer box pad of claim 28, wherein the top includes a first aperture and the base includes a second aperture, and wherein a fastener is inserted through the first aperture and the second aperture to couple the top to the base.

32. The transformer box pad of claim 28, further comprising a rib disposed on an inner surface, wherein the rib is disposed proximate to an upper end of the base and extends partially toward a lower end of the base; and wherein a lower end of the rib substantially does not extend inferior to an upper end of the louver.

33. (canceled)

34. The transformer box pad of claim 28, wherein the louver includes a front wall and a pair of side walls that are inclined relative to the front wall.

35.-40. (canceled)
